(19) United States
(12) Patent Application Publication
(10) Pub. No.: US 2006/0292984 A1
(43) Pub. Date: Dec. 28, 2006

(54) RFID VEHICLE-TRACKING SYSTEM USING MOBILE TRANSCEIVERS AND STATIONARY TRANSPONDERS

(75) Inventors: Anthony Alonzo Teate, Harrisonburg, VA (US); Renee Marie Parilak, Harrisonburg, VA (US)

Correspondence Address: ANTHONY A. TEATE, 1655 PARKLAWN DR., HARRISONBURG, VA, 22801, US

(73) Assignees: Anthony Alonzo Teate, Harrisonburg, VA (US); Renee Marie Parilak, Harrisonburg, VA (US)

(21) Appl. No.: 11/160,447

(22) Filed: Jun. 23, 2005

(51) Int. Cl. H04B 7/00

(52) U.S. Cl. 455/41.2

(57) ABSTRACT

The invention disclosed in this document is a vehicle tracking system using Radio Frequency Identification (RFID) transponders and an RFID transceiver, which is attached to a moving vehicle to collect vehicle location data. Each location code is encoded on a transponder, which is then embedded at a location along a vehicle's route to be read by the transceiver as the vehicle passes nearby. The data read by the transceiver is transmitted to the Internet using a mobile communication device like a cell phone. By having fixed transponder locations and a transceiver that is on the moving vehicle, this system becomes the reverse of the typical RFID item-tracking system. In addition, it is able to use the data stored on the RFID transponders, read by the RFID transceivers, and processed by the data storage and processing device to determine whether a vehicle is on its predetermined route, estimate when the vehicle will arrive at future stops on its scheduled route, and determine whether it is on schedule. This RFID vehicle-tracking system is therefore unique.

### BACKGROUND OF THE INVENTION

1. Field of Invention

This invention relates to item-tracking devices, specifically to an improved radio frequency identification (RFID) vehicle-tracking system.

2. Discussion of Prior Art

Several radio frequency identification (RFID) systems have been developed in recent years to track mobile items like vehicles, products, or animals. RFID systems work by using a transceiver-transponder system. The transceiver (also called an RFID reader) sends out a signal, which activates transponders (also called RFID tags) in the immediate area surrounding the transceiver. The transponders then reply with an encoded message, which is received by the transceiver and interpreted by a computer system connected to the transceiver.

Because each RFID transponder is encoded with unique data or information, items can be uniquely identified and located as they are brought within range and read by a transceiver. For instance, when pallets of products are outfitted with RFID transponders at a manufacturing plant, then shipped to a warehouse on a truck, the truck can simply drive within range of a RFID transceiver as it arrives at the warehouse, and all of the pallets of products that are on the truck are identified immediately upon arrival and added to the warehouse inventory. RFID systems help companies track fleets of vehicles, products throughout the supply chain, and inventory levels at a particular location. The same type of system has been used to track livestock throughout the agriculture and food industries, as described in U.S. Pat. No. 6,664,897 by Pape et al. A slightly modified RFID transceiver-transponder system can be used for personnel tracking and access control within a secure facility.

However, all of these previously developed RFID tracking systems have one thing in common: RFID transceivers that are stationary (or handheld transceivers that must to be docked or connected to a wireless network to transmit data) and transponders that are placed on the items to be tracked, and therefore are mobile. As the tagged items move within range of the transceiver, they can be located and logged in the computer system. In applications where the transponders needed far outnumber the transceivers, this setup works well.

There are some applications, however, in which the previously described RFID item-tracking system would be both cost-prohibitive and difficult to maintain. For instance, if one wanted to track the location of a public transportation vehicle such as a bus that follows a designated route within a city using the aforementioned system, each bus would contain an RFID transponder, and each bus stop or street corner would need to be outfitted with a RFID transceiver setup that is connected to a computer network. As the bus passed the bus stop or street corner, the transceiver at that location would activate and read the transponder on the bus and log the current time, then use the unique code on the transponder to identify the bus. The bus' arrival time at each stop could be logged using a computer connected to the internet, and the data could be collected on a computer server and used to track buses throughout the city, predict future arrival times, and provide useful information to dispatchers and customers. Because the bus stops far outnumber the buses in a typical city, the more-expensive transceivers would be more numerous than the less-expensive transponders in the system described above. In addition, computer equipment would have to be purchased, set up, protected, and maintained at each bus stop location, and each location would need to have internet access to allow for data transmission. Because of the vulnerability of the equipment to natural elements and theft, and because of the sheer number of transceivers and computer systems needed to outfit each bus stop or street corner, the system becomes unreasonably costly to implement.

Another vehicle tracking method is described in U.S. Pat. No. 5,895,436 by Savoie and Boulay. This system utilizes the cellular network to locate vehicles by paging a cellular transceiver, which has been installed on the vehicle, to identify which cell sites are near the vehicle. Once this general area in which the vehicle is located has been identified, a person searching for the vehicle then travels to the vicinity of the cell sites and uses a radio direction finder to locate and track the vehicle. This system is useful for finding a stolen vehicle, but the complicated tracking method and non-specific location results limits its use to very specific vehicle-tracking applications.

There are also Global Positioning Systems (GPS) like that described in U.S. Pat. No. 6,789,013 by Annett and Swarbeick that are used to track vehicles. GPS has valuable features, such as the ability to track a vehicle's location continuously, even off-route, and the ability to use that information to determine its speed and direction. However, GPS systems are both expensive and hard to set up for vehicles on a set route. Users of a GPS vehicle-locating system can see the vehicle's position on a map, but the map has to be customized to include the bus routes and stops, which can only be added after a large amount of GPS location data has been gathered, and only if the mapping software is customizable. In order to determine how far a bus was from its next planned stop, the GPS data would need to be interpreted to locate the vehicle's position on a predetermined route and determine which stops are nearby. The transportation authority would also need to purchase a subscription to a GPS satellite communication service, which can become costly when the location is being queried for several vehicles constantly, since the cost of the subscription is based on the amount of data being transferred.

A system was designed by Ohanes Ghazarian and presented in U.S. Pat. No. 7,034,683 in which RFID tags are used to secure and track vehicle cargo contents. The RFID tags in Ghazarian's patent are attached to objects and are read by RFID readers attached to vehicles and at site stations. The readers (transceivers) are mobile in this case, but the tags are also. Because the RFID tags are not at fixed locations, they cannot be used to locate the vehicle geographically. GPS receivers embedded within the tags are used to locate the items when not in range of a reader, and the RFID tag is used to locate an item only as it nears or enters a location or vehicle. An RFID reader/transceiver on the vehicle is used to identify the vehicle and determine whether it is at a specified location, but another RFID reader is required at the location to transmit the tag data from the vehicle to the CPU at the location. Again, this system has unnecessary expenses for simple route-vehicle tracking. Though it does track cargo items, the system is more complex than desired as described in the bus tracking example above, and RFID tags are not located at fixed points along a route for vehicle-location purposes.

Der Ghazarian et al submitted a patent application that has stationary receivers and transmitters, and mobile transceivers. This application has been published as US 2002/0128769. In this embodiment, Der Ghazarian has a plurality of parking spaces with both an RF receiver and an RF transmitter. Der Ghazarian also describes a plurality of vehicles able to transmit and receive RF signals. In addition, a base station is outfitted with a transceiver unit to transmit and receive RF signals. In this system, the parking space units are communicating with the base station computer, the vehicle units are communicating with the base station computer, and the vehicle units are communicating with the parking space units. Additional claims are made describing a hand-held computer with an RF transceiver as well as several security features included in this system. This system, like the system described in the previous paragraph, is more complex and more expensive than desired for tracking a vehicle on a route. Using this system in a city bus tracking application would put expensive equipment on the streets that would need to be protected from theft, tampering, and damage by weather. The entire “parking space unit” would have to be installed at each bus stop to use this system to track buses on a route. In addition, because vehicles are being located in parking lots and not on a driving route in Der Ghazarian's system, no claims are made for a system to track vehicles on a route, predict when a vehicle will arrive at a particular location, or determine whether a vehicle is on schedule. There is also no claim made for a public user display of vehicle location data.

One additional patented invention is described by Kenneth Flick as a vehicle-tracking device in U.S. Pat. No. 7,015,830B2. The invention disclosed in Flick's specification includes methods for controlling operable vehicle devices, a vehicle data bus, a vehicle position-determining device, and a wireless communications device. This system monitors vehicle system status and location using a device such as a GPS unit, and broadcasts the information gathered via a wireless network or cell phone communications system. Flick does not teach that the vehicle is located using a stationary-transponder and mobile-transceiver system. Because the invention was not designed to track a vehicle along a fixed route, it has no capability for predicting arrival time at another location or determining whether the vehicle is on-schedule and on-route.

### OBJECTS AND ADVANTAGES

Our solution is to reverse the typical RFID tracking system—attach the transceivers to the vehicle to be tracked (in this example, the bus), and attach the transponders to the stationary items (in this example, the bus stops). The system we describe in this specification also includes a data storage and processing device with the ability to compare the position and time data collected by the RFID transceiver on the vehicle to previously stored data in order to determine whether the vehicle is on-route, determine whether the vehicle is on-schedule, and estimate when it should arrive at its next destination.

Several objects and advantages of the invention are:
a) to reduce the cost compared to existing vehicle-tracking systems by requiring less expensive equipment;
b) to better protect the RFID Transceivers from weather, tampering, and theft compared to the traditional RFID system setup by placing them on the vehicle;
c) to require less maintenance by having fewer RFID Transceivers and computer systems and more low-maintenance RFID transponders at fixed locations;
d) to provide the now-mobile RFID Transceiver with a means of wirelessly communicating with the Internet to transfer location and time data;
e) to provide a means of tracking vehicles that is not reliant on GPS satellites or proprietary communication network systems;
f) to provide a means of determining whether a vehicle is following its predetermined route;
g) to provide a means for determining whether a vehicle is on schedule;
h) to provide a means for estimating when a vehicle is to arrive at the next stop on its route.

Further objects and advantages include providing a means of displaying to both managers and users of a transportation system whether the vehicles are running on time, where they are currently located, and also providing an estimated arrival time to the next planned stop on a times at stops on the route.

Still further objects and advantages will become apparent from a consideration of the ensuing description and drawings.

### SUMMARY

In accordance with the present invention, a RFID vehicle tracking system with mobile transceivers and stationary transponders comprises a plurality of transponders at fixed locations, a mobile communication device, a transceiver with the ability to exchange data with said transponders and said mobile communication device, a data storage and processing device that is connected to the internet, means for said mobile communication device to transmit data to said data storage and processing device, means for said data storage and processing device to compare collected data to stored data to determine a vehicle's route and schedule status, and a graphical user interface for displaying processed data to a human user.

### DESCRIPTION OF DRAWINGS

FIG. 1. Pictorial representation of a RFID Vehicle-Tracking System Using a Mobile Transceiver and Stationary Transponders

### DETAILED DESCRIPTION

### PREFERRED EMBODIMENT

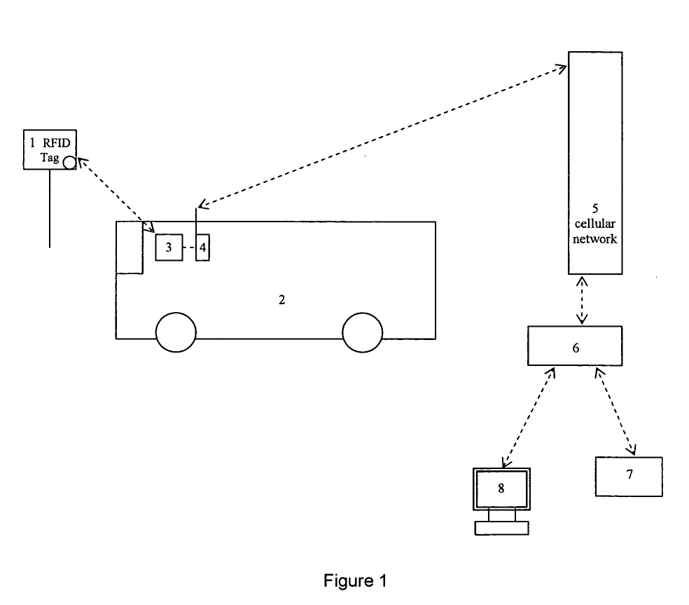

FIG. 1 shows a representation of our RFID Vehicle-Tracking System. In this version, a bus is tracked by logging its location, vehicle identifier, and the current time as it passes each bus stop on its route. Each bus stop contains a transponder or RFID Tag (1), which can be read by the RFID Reader, mobile transceiver, or interrogator (3) which is mounted on the vehicle or bus (2). When the RFID tag (1) is read by the RFID reader (3), the tag's location data is sent to the mobile communication device or cell phone (4) which logs the location, vehicle identifier, and the current time and sends that information via a wireless communication method or cell network (5) to the Internet or computer network (6). A data storage and processing device or computer (7), which is connected to the Internet (6) will then receive the transmission and store the vehicle identifier, time, and location data, and process the data so route- and schedule-related information can be displayed in a useful manner to the end-user as a webpage, LCD display, or other electronic representation of the data (8).

### Alternate Embodiments

Some alternate embodiments include:
replacing the RFID transceiver and cell phone in the preferred embodiment with a notebook computer that has an RFID reader peripheral attachment and a cell-network-enabled modem.
if it is extensive enough, using a city's public wireless internet system to transmit data between the transceiver and computer on the network instead of using the cell phone network.
using the system to track any vehicle on a fixed route other than a bus, like trains on a track, forklifts within a storage facility, or golf carts on a course.
enhancing the system to capture and send data other than vehicle number, location number, and time, such as speed of the vehicle or current number of passengers.

### CONCLUSION, RAMIFICATIONS, AND SCOPE OF INVENTION

The reader will see that the vehicle-tracking system of the invention can provide a simple and economical way to track vehicles on a route without requiring a subscription to a GPS service or expensive vehicle detection equipment at each street corner. The only part of the system that is exposed to weather or tampering is the low-cost transponder at each bus stop or street corner that is encoded with the location information. The public transportation routes in most cities have cell phone coverage and this vehicle-tracking system can utilize that existing communication network. The system is automatic and run by computers and therefore requires no human data input or manual data transmission. The data collected can be compared to stored route and schedule data by the data storage and processing device to determine whether a vehicle is on-route and on-schedule. The comparisons and calculations made with this data will generate results that can be displayed to public transportation users and managers so they can easily determine whether a bus is running on schedule and when it will arrive at other stops on its route. This displayed information can be updated real-time based on the actual time of the RFID tag scan and the system-determined location of the bus.

By implementing this system in a city to track public bus locations, dispatchers will also have a visual way to locate buses without disturbing the drivers.

The ramifications of a well-run bus system with real-time vehicle location are extensive. By providing an effective and easy-to-use public transportation system, a city can increase the number of people that choose to use the transit system instead of driving, therefore decreasing traffic and pollution. The bus locations are also known in the event of an emergency where rerouting becomes necessary.

In addition, data collected by the system over time can be used to detect scheduling problems where buses consistently run late and route schedules or bus routes therefore need to be changed.

In an alternate embodiment, the vehicle-tracking system of the invention can be used to track forklifts in a storage facility, so the nearest forklift can be dispatched to retrieve materials and therefore the system can be run more efficiently. It could also be used to locate golf carts on a golf course to allow the course attendants to provide customer service like delivery of food or drinks to the customer's current location, or to detect when a delay has occurred and several customers are waiting at one hole.

Obviously, these are just a few uses of the invention described in this document, because vehicles are put to limitless uses and many of those uses involve vehicles running on a predetermined route, allowing them to be tracked using stationary transponders and mobile transceivers as described.

1. A vehicle tracking system, comprising:
a) A plurality of transponders at fixed locations
b) A moving vehicle
c) A transceiver on said vehicle with the ability to exchange electronic data wirelessly with said transponders
d) A mobile communication device on said vehicle
e) Means to provide power to said transceiver and said mobile communication device
f) Means for electronic data exchange between said transceiver and said mobile communication device
g) A data storage and processing device that is connected to the internet
h) Means for said data storage and processing device to determine whether vehicle is on-route and on-schedule
i) Means for said data storage and processing device to calculate estimated vehicle arrival times
j) A graphical user interface for displaying processed data to a human user
k) Means for said mobile communication device to transmit data to said data storage and processing device to be displayed on said graphical user interface.

2. The vehicle tracking system of claim 1 wherein said transponders are radio frequency identification tags and said transceiver is a radio frequency identification tag reader.

3. The vehicle tracking system of claim 1 wherein said mobile communication device is a celluar telephone.

4. The vehicle tracking system of claim 1 wherein said mobile communication device is an internet-enabled mobile computer.

5. The vehicle tracking system of claim 1 wherein said means to provide power to said transceiver and said mobile communication device is a battery.

6. The vehicle tracking system of claim 1 wherein said vehicle has an auxiliary power system.

7. The vehicle tracking system of claim 6 wherein said auxiliary power system provides power to said transceiver and said mobile communication device.

8. The vehicle tracking system of claim 1 wherein said data storage and processing device is a personal computer.

9. The vehicle tracking system of claim 1 wherein said graphical user interface for displaying processed data is an Internet webpage.

10. The vehicle tracking system of claim 1 wherein said graphical user interface for displaying processed data is a light-emitting diode display.
